(19) United States
(12) Patent Application Publication
(10) Pub. No.: US 2003/0189043 A1
(43) Pub. Date: Oct. 9, 2003

(54) Electrical box extension

(76) Inventors: Wesley Gene Wegner, Thousand Oaks, CA (US); Paul Brett Wegner, Los Angeles, CA (US)

Correspondence Address: MICHAEL BLAINE BROOKS, A PROFESSIONAL CORPORATION, 5010 NO. PARKWAY CALABASAS, SUITE 104, CALABASAS, CA, 91302-3913, US

(21) Appl. No.: 10/144,210

(22) Filed: May 13, 2002

Related U.S. Application Data
(60) Provisional application No. 60/370,419, filed on Apr. 4, 2002.

(51) Int. Cl. H02G 3/08; B65D 6/28; B65D 8/18

(52) U.S. Cl. 220/4.03

(57) ABSTRACT

Disclosed is an electrical box extension that is a combination of a tubular sleeve with one or more fastening brackets, an electrical box adaptor plate with one or more fastening brackets and one or more double reverse screws as the preferred fasteners for mechanically and electrically connecting the tubular sleeve and the adaptor plate via the brackets providing sufficient mechanical resistance to support the adjustable elevation of the tubular sleeve thereby providing a flush surface for surface mounted sockets, switches and their associated plates.

### CROSS REFERENCE TO RELATED APPLICATIONS

This application claims priority from the following U.S. Provisional Patent Application, the disclosure of which is incorporated by reference in its entirety for all purposes: U.S. Provisional Patent Application Ser. No. 60/370,419, Wesley Gene Wegner and Paul Brett Wegner entitled, “ELECTRICAL BOX EXTENSION,” filed Apr. 4, 2002.

### BACKGROUND

1. Field of the Invention

This invention generally relates to electrical equipment for housing electrical devices such as switches and outlets, and particularly to electrical box extensions.

2. Description of Prior Art

Electrical boxes are commonly used to provide electrical service at convenient locations within buildings. The electrical boxes are commonly formed of plastic or metal and are usually securely fastened by screws or nails to the framework of the building. In newly constructed buildings, the open face of the electrical box, in which an electrical device such as an outlet or switch will be mounted, is usually flush with the surface of the wall or ceiling in which it is installed.

When existing buildings are renovated or restored, it is common for renovators to lay down new sheet stock such as sheet rock, paneling, and the like, over the existing ceilings or walls. This causes the existing electrical boxes to become recessed within the wall by the thickness of the new sheet stock.

To solve this problem, box extenders of several different types have been developed. One type relies on a friction fit to hold the box extender in the existing electrical box. This extender has the disadvantage of not providing a secure attachment to the existing box, and the electrical device may slide further within the box making it hard to reach.

Another type of extender consists of an extension having walls of approximately the same configuration as the existing box and of fixed thickness. The extender is available in several thicknesses to accommodate several different sheet stock thicknesses. Although there are many thicknesses available, the extender sometimes is not of a proper thickness to bring the existing box flush with the new surface, and this creates an aesthetically undesirable appearance.

Another type of extender includes a body portion having at least one wall and open faces. The extender includes side flanges having holes that align with brackets that are connected to the electrical box. This extender is difficult to use and install as brackets must be firmly attached to the electrical box and then two screws are used to attach each flange of the extender to the electrical box.

### OBJECTS AND ADVANTAGES

A principal object of this invention is to extend the electrical box with a minimal number of parts that provide ready height adjustment while maintaining mechanical and structural soundness and electrical connectivity including ground, and thereby compensate for add-ons to a wall that cause depth to be added between the box or ring and the outer wall. As discussed above, a need for extension occurs when the box or ring has been placed and then tile, brick or some other wall covering is added thereby causing the screw mounts to be recessed within the wall.

### SUMMARY

An electrical box extension comprised of a tubular sleeve with a plurality of fastening brackets, an electrical box adaptor plate with a plurality fastening brackets and one or more elevating fasteners such as double reverse screws for mechanically and electrically connecting the tubular sleeve and the adaptor plate via the fasteners and brackets thereby providing sufficient mechanical resistance to support the adjustable elevation of the tubular sleeve and providing a flush surface for surface mounted sockets, switches and their associated plates.

### BRIEF DESCRIPTION OF THE DRAWINGS

For a more complete understanding of the present invention and for further features and advantages, reference is now made to the following description taken in conjunction with the accompanying drawings, in which:

FIG. 1 is a top view of the present invention;

FIG. 2 is a side view of the present invention;

FIG. 3 is a perspective view of the present invention mounted on an electrical box.

FIG. 4 is a top view of the present invention mounted on an electrical box; and

FIG. 5 is a perspective view of the present invention mounted on an electrical box.

### DETAILED DESCRIPTION OF THE PREFERRED EMBODIMENT

The extension, or sliding tubular member, is an attached, adjustable addition to the ring, box, or adapting member. While the drawings reflect a box ring, the invention may be embodied with an electrical box made of plastic, metal, ceramic or combinations thereof. In addition, the term electrical box is used generically to refer to grounded electrical housing of three-diminsional shapes including boxes of rectangular sides, boxes of square sides, and boxes of cylindrical shapes with circular or oval tops and bottoms.

The preferred embodiment has at least two sets of mounting brackets, preferably placed in each of two diametrically opposed corners. Additional sets of mounting brackets may be required depending primarily upon the ring/box size. One bracket is placed at the base of the ring and extends into the open portion of the ring. The second bracket is placed approximately midway between the base and top of the ring. These each have a tapped entry for a left/right thread screw. By turning either screw, the extension can be elevated or lowered such that the outer edge can match the wall surface. The design of the brackets and screw mounting effects a solid ground and satisfies the electrical grounding requirements.

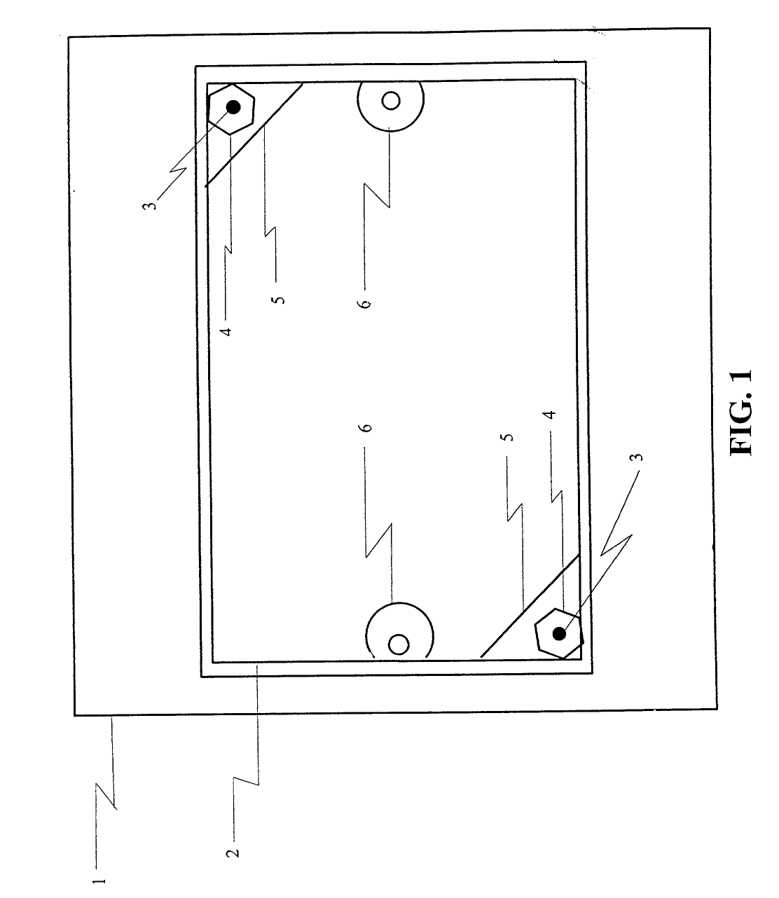

FIG. 1 illustrates the screw mounting plates 6 of the present invention that are placed such that a reverse thread screw 3 functions with at least two brackets, a upper bracket 4 and a lower bracket 5, to lower and raise the extension 2 relative to the ring 1. While a reverse thread screw is shown as the preferred fastener, other fasteners of adjustable height that provide mechanical and electrical connectivity may be substituted. The extension is preferably a tubular member with a transversal shape that is substantially rectangular. The transversal shape may also be circular, oval or multifaceted. The switch/plug screw plates 6 can be a part of the extension 2 or the extension 2 can be embodied alternatively such that the end portions of the extension 2 fit about the plates 6. In the preferred embodiment, the lower bracket 5 is fixedly attached to the ring 1. Alternatively, the lower bracket 5 may be fixedly attached to an electrical box (not shown).

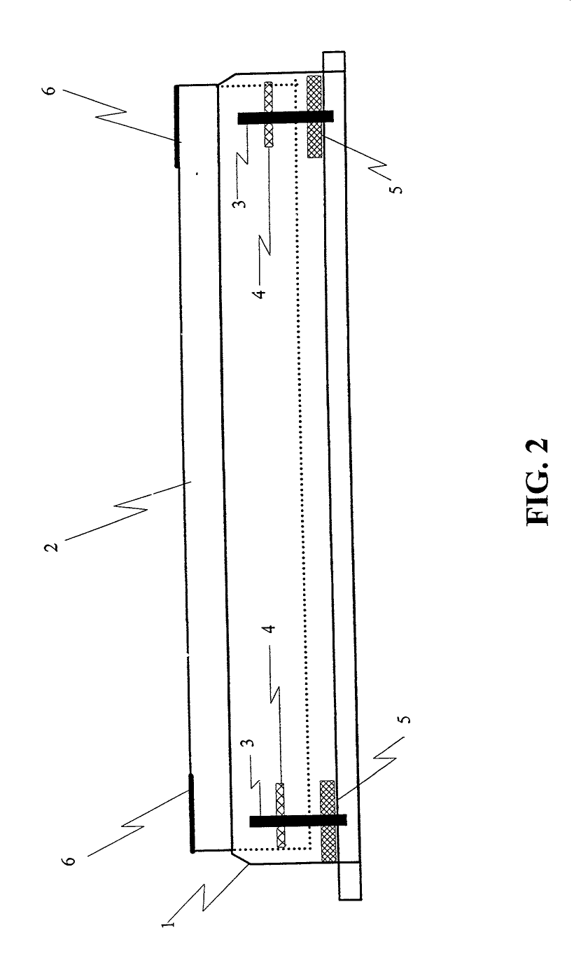

FIG. 2 illustrates the manner in which the screws 3 fit into each of the mounting brackets. The lower bracket 5 is fixedly attached to the ring 1. The upper bracket 4 is fixedly attached to the extension 2. By turning the one or more screws 3, the extension 2 rises or falls depending upon the turn of the one or more screws 3.

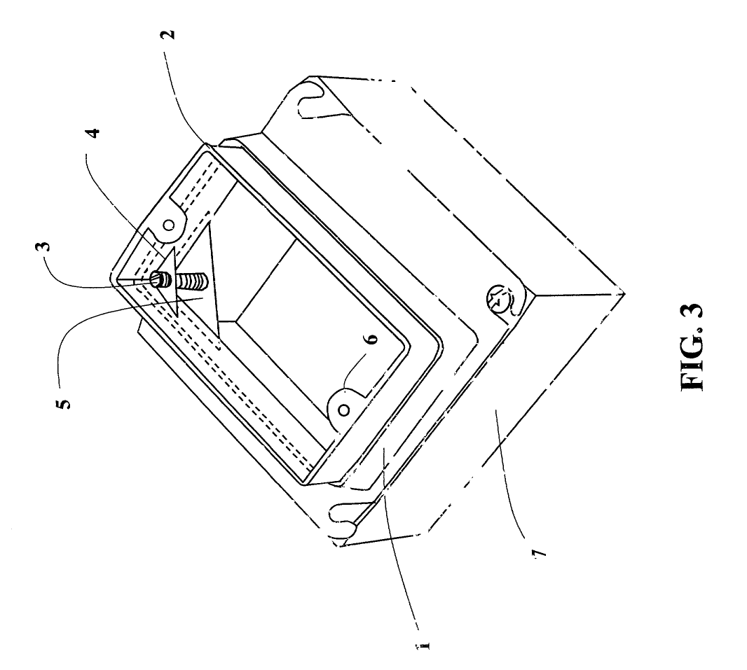

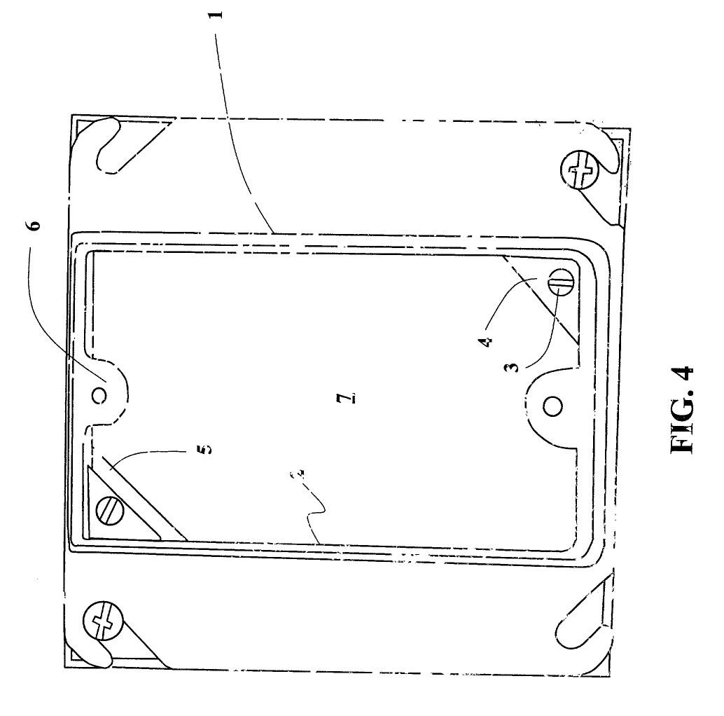

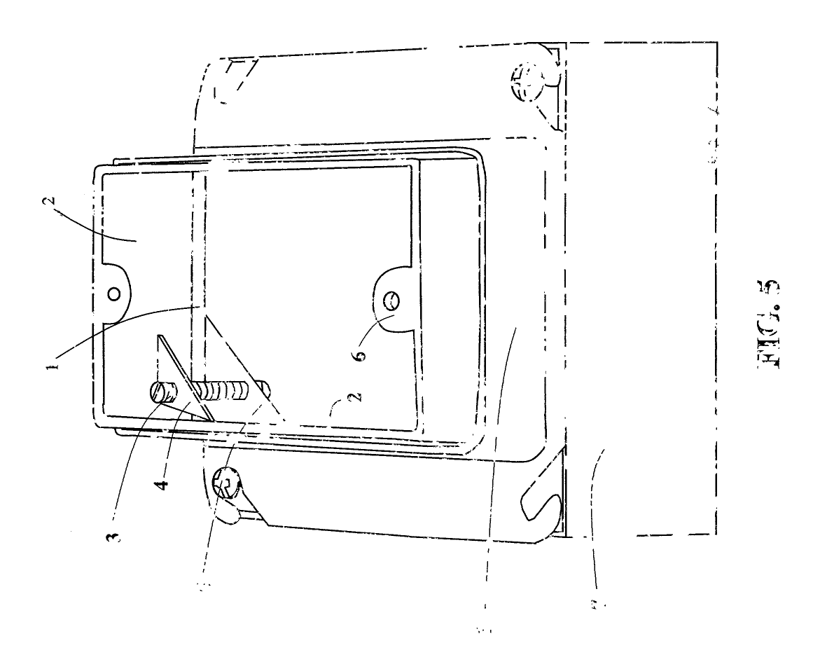

FIGS. 3-5 illustrate the present invention from various perspectives as it is mounted on an electrical box 7. FIG. 3 provides a perspective view of the present invention mounted on an electrical box 7. The extension 2 is shown within the flange of the ring 1. A screw 3 is visible mechanically connecting the extension 2 to the ring 1 by way of a lower bracket 5 fixedly attached to the ring 1 and an upper bracket 4 fixedly attached to the extension 2. The upper and lower brackets are also referred to as a set or pair of brackets 4 and 5. FIG. 4 provides a top view of the present invention mounted on an electrical box and shows the preferred embodiment with a screw 3 and pair of brackets 4 and 5 diagonally opposed from a second screw 3 and pair of brackets. FIG. 5 is a perspective view of the present invention mounted on an electrical box and illustrated the typical travel of the extension 2 relative to the remaining screw thread.

Rather than the one or more lower brackets 5 being fixedly attached to the ring 1, they can instead be fixedly attached to the box 7. The extension 2 remains in electrical and mechanical contact with the box by way of the one or more screws 3 as disclosed above. Depending on the dimensions of the box 7, a ring 1 thereby becomes optional in this alternative embodiment.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result.

In addition to the equivalents of the claimed elements, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. An electrical box extender for extending an electrical box so that the extended electrical box is substantially flush with a surface comprising:
an adapting member having an outward side and an inward side and having a flange substantially perpendicular and integral to the adapting member; said flange having an inward side and an outward side; said flange continuously bordering an aperture of said adapting member and oriented substantially about an axis of said adapting member;
one or more adaptor fastener mounting plates attached to the inward side of said flange, each for receiving a fastener therein;
a sliding member oriented in close proximity to the inside of said flange having one or more extender fastener mounting plates, each for receiving a fastener, fixedly attached; each extender fastener mounting plate substantially aligned with one of the adaptor screw mounting plates;
one or more fasteners for detachably attaching said adapting plate to said sliding member by way of the aligned fastener mounting plates;
whereby the extending of the length of the fasteners between the adaptor fastener mounting plates and the extender fastener mounting plates maintains mechanical and electrical connectivity while modifying the height of the sliding member relative to the adapting member in an adjustable and reversible fashion.

2. The electrical box extender as claimed in claim 1 wherein the one or more adaptor fastener mounting plates are one or more adaptor screw mounting plates, the one or more extender fastener mounting plates are one or more extender screw mounting plates, and the one or more fasteners are one or more reverse thread screws, whereby the turning of the one or more reverse thread screws maintains mechanical and electrical connectivity while modifying the height of the sliding member relative to the adapting member in an adjustable and reversible fashion.

3. The electrical box extender as claimed in claim 2 wherein the sliding member is a tube of substantially rectangular shape in transverse.

4. The electrical box extender as claimed in claim 2 wherein the sliding member tube of substantially circular shape in transverse.

5. The electrical box extender as claimed in claim 2 wherein the sliding member tube of substantially oval shape in transverse.

6. The electrical box extender as claimed in claim 1 wherein the one or more adaptor fastener mounting plates are one or more adaptor expandable fastener mounting plates, the one or more extender fastener mounting plates are one or more extender expandable fastener mounting plates, and the one or more fasteners are one or more expandable fasteners, whereby the extending and retracting of the expandable fasteners maintains mechanical and electrical connectivity while modifying the height of the sliding member relative to the adapting member in an adjustable and reversible fashion.

7. The electrical box extender as claimed in claim 6 wherein the sliding member is a tube of substantially rectangular shape in transverse.

8. The electrical box extender as claimed in claim 6 wherein the sliding member tube of substantially circular shape in transverse.

9. The electrical box extender as claimed in claim 6 wherein the sliding member tube of substantially oval shape in transverse.

10. An electrical box extender for extending an electrical box so that the extended electrical box is substantially flush with a surface comprising:
an adapting member having an outward side and an inward side and having a flange substantially perpendicular and integral to the adapting member; said flange having an inward side and an outward side; said flange continuously bordering an aperture of said adapting member and oriented substantially about an axis of said adapting member;
a plurality of adaptor screw mounting plates attached to the inward side of said flange, each for receiving a screw therein;
a sliding tubular member oriented in close proximity to the inside of said flange having a plurality of extender screw mounting plates, each for receiving a screw; each extender screw mounting plate substantially aligned with one of said plurality of adaptor screw mounting plates;
a plurality of reverse thread screws for detachably attaching said adapting plate to said sliding tubular member by way of the aligned screw mounting plates;
whereby the turning of the one or more reverse thread screws maintains mechanical and electrical connectivity while modifying the height of the sliding tubular member relative to the adapting member in an adjustable and reversible fashion.

11. An electrical box extender for extending an electrical box so that the extended electrical box is substantially flush with a surface comprising:
the electrical box having an outward side and an inward side; a plurality of adaptor fastener mounting plates attached to the inward side of the electrical box, each for receiving a fastener therein;
a sliding member, oriented in close proximity to at least two sides comprising the inside of said electric box, having a plurality of extender fastener mounting plates, each for receiving a fastener; each extender fastener mounting plate substantially aligned with one of said plurality of adaptor fastener mounting plates;
one or more fasteners for detachably attaching said adapting plate to said sliding member by way of the aligned fastener mounting plates;
whereby the extending of the length of the fasteners between the adaptor fastener mounting plates and the extender fastener mounting plates maintains mechanical and electrical connectivity while modifying the height of the sliding member relative to the box in an adjustable and reversible fashion.

12. The electrical box extender as claimed in claim 11 further comprising an adapting member having an outward side and an inward side.

13. The electrical box extender as claimed in claim 11 wherein said adapting member further comprises a flange substantially perpendicular and integral to the adapting member; said flange having an inward side and an outward side; said flange continuously bordering an aperture of said adapting member and oriented substantially about an axis of said adapting member.

14. The electrical box extender as claimed in claim 11 wherein the one or more adaptor fastener mounting plates are one or more adaptor screw mounting plates, the one or more extender fastener mounting plates are one or more extender screw mounting plates, and the one or more fasteners are one or more reverse thread screws, whereby the turning of the one or more reverse thread screws maintains mechanical and electrical connectivity while modifying the height of the sliding member relative to the box in an adjustable and reversible fashion.

15. The electrical box extender as claimed in claim 11 wherein the sliding member is a tube of substantially rectangular shape in transverse.

16. The electrical box extender as claimed in claim 11 wherein the sliding member tube of substantially circular shape in transverse.

17. The electrical box extender as claimed in claim 11 wherein the sliding member tube of substantially oval shape in transverse.

18. The electrical box extender as claimed in claim 11 wherein the one or more adaptor fastener mounting plates are one or more adaptor expandable fastener mounting plates, the one or more extender fastener mounting plates are one or more extender expandable fastener mounting plates, and the one or more fasteners are one or more expandable fasteners, whereby the extending and retracting of the expandable fasteners maintains mechanical and electrical connectivity while modifying the height of the sliding member relative to the adapting member in an adjustable and reversible fashion.

19. The electrical box extender as claimed in claim 18 wherein the sliding member is a tube of substantially rectangular shape in transverse.

20. The electrical box extender as claimed in claim 18 wherein the sliding member tube of substantially circular shape in transverse.

21. The electrical box extender as claimed in claim 18 wherein the sliding member tube of substantially oval shape in transverse.
